(19) United States
(12) Patent Application Publication
(10) Pub. No.: US 2004/0074337 A1
(43) Pub. Date: Apr. 22, 2004

(54) Preparation and controlled oxidation of an active nickel catalyst particulate

(76) Inventors: Srinivasan Venkatesan, Southfield, MI (US); Boyko Aladjov, Rochester Hills, MI (US); Subhash K. Dhar, Bloomfield, MI (US); Stanford R. Ovshinsky, Bloomfield Hills, MI (US)

Correspondence Address: ENERGY CONVERSION DEVICES, INC., 2956 WATERVIEW DRIVE, ROCHESTER HILLS, MI, 48309, US

(21) Appl. No.: 10/273,508

(22) Filed: Oct. 18, 2002

(51) Int. Cl. B01J 25/02; B22F 9/04

(52) U.S. Cl. 75/370; 502/301

(57) ABSTRACT

A process for preparing and passivating Raney nickel from a 50:50 aluminum-nickel alloy. The aluminum-nickel alloy is etched to form Raney nickel. The Raney nickel is then suspended in water and introduced to oxygen bubbled into the suspension thereby passivating the Raney nickel.

### FIELD OF THE INVENTION

The present invention relates generally to a process for preparing passivated Raney nickel powder. More particularly, the present invention relates to a etching and controlled oxidation process useful for preparing passivated Raney nickel powder from an aluminum-nickel alloy.

### BACKGROUND

Raney Nickel is a catalyst used extensively for hydrogenation reactions in the organic chemical industry. Hydrogenation of oils and fats to form margarine is one example of the many uses for Raney Nickel. Raney catalysts in general have been named after Raney, the inventor, for a variety of catalysts the most useful being Raney Nickel, Raney Cobalt, Raney Silver, and Raney Copper. All of these catalysts start off as 50:50 alloy of Aluminum and the catalyst metal. Such catalyst metals may include nickel, cobalt, silver, or copper. For example an alloy of 50:50 Ni/Al is powdered and granulated and is generally sold as 1-2 mm size particles. When the Ni/Al alloy is put in contact with hot alkaline solution, the aluminum dissolves in solution leaving behind finely divided nickel particulate. The aluminum hydroxide then redissolves in excess alkali to form aluminate. The reactions of which are shown below.

Ni/Al+3OH⁻->Ni+Al(OH)₃ (Aluminum Hydroxide)

Al(OH)₃->AlO₂²⁻ (Aluminate)

As a side reaction of aluminum corrosion, hydrogen is liberated on impurity sites and on nickel surfaces. This hydrogen is in the nascent form and is easily adsorbed at the nickel surface. When the finely divided nickel with adsorbed hydrogen is exposed to air, it tends to spontaneously oxidize. This spontaneous oxidation can cause the material to become pyrophoric. Whether the fine particle size of the nickel or the presence of adsorbed hydrogen is responsible for the combustion in air is not clear. However, a Raney catalyst with an oxide covered surface is not useful as a catalyst. As a result, the Raney nickel is supplied as a suspension in water or as untreated alloy. Handling and transportation of activated Raney Nickel is generally considered a hazard and elaborate precautions are taken.

Some of the manufacturers have adapted special techniques to render the pyrophoric powder inert. This passivation treatment involves electrochemical anodic oxidation of the powder suspension in a rotating barrel. In some other cases, the powder is chemically washed with oxidizing agents to passivate its surface. There are, however, inherent disadvantages to these methods. The electrochemical process is elaborate and the oxidation of the powder occurs only when the powder is in contact with the anode. The rotating slurry will also make contact with the cathode creating a danger of the passivating layer being electrochemically reduced. If the slurry forms any continuous metal particle stream, there is a danger of short circuit formation leading to sparking. Chemical oxidants usually leave behind oxide films with cationic species in them. (For example if chromates or di-chromates are used as oxidizing agents, the passivating film will have an oxide layer containing Cr in it). Some of the chemical oxidants may also be environmentally unacceptable, in the case of Chromium.

The present invention provides a process for preparing passivated Raney Nickel using etching and controlled oxidation techniques. The present invention is deceptively simple but very effective and does not involve either electrochemical oxidation or oxidation via the use of oxidants. The process is relatively inexpensive as compared with other passivation techniques, self controlling, uses no expensive electrochemical instrumentation or rotating drums, scalable, and provides no environmental implications.

### SUMMARY OF THE INVENTION

The present invention discloses a process for the production of passivated Raney nickel powder from an aluminum-nickel alloy. The process for producing a passivated Raney nickel particulate comprises the steps of 1) etching an aluminum-nickel alloy in an alkali solution to form a Raney nickel particulate, 2) suspending the Raney nickel particulate in deionized water at room temperature, 3) agitating the Raney nickel particulate suspension, and 4) bubbling an oxygen containing stream into the Raney nickel particulate suspension. The aluminum-nickel alloy used to produce the Raney nickel is a 50:50 aluminum-nickel alloy.

The passivation process should last approximately 5.5 hours during which an oxygen containing stream is bubbled into the Raney nickel suspension. To ensure proper passivation of the Raney nickel, the temperature of the Raney nickel particulate suspension should rise to at least 30° C. after 1 hour, at least 40° C. after 2 hours, and at least 42° C. after 3 hours. The temperature should then remain at a minimum of 42° C. after 4 and 5 hours.

After the Raney nickel has been passivated, the Raney nickel suspension is allowed to settle, the supernatant liquid is removed, and the passivated Raney nickel particulate is allowed to air dry for at least 24 hours.

### BRIEF DESCRIPTION OF THE DRAWINGS

FIG. 1, is a depiction of the apparatus used to etch the Raney nickel in accordance with the present invention.

FIG. 2, is a depiction of the apparatus used to passivate the active nickel catalyst particles in accordance with the present invention.

FIG. 3, is a depiction of an apparatus that may be to produce the active nickel catalyst particulate in accordance with the present invention.

### DETAILED DESCRIPTION OF THE INVENTION

The present invention discloses an etching and controlled oxidation process for preparing passivated active nickel catalyst from an aluminum-nickel alloy. The present invention puts to use the principle that oxygen is soluble in water and the solubility at a given pressure and temperature is constant. As taught by Henry's law, the higher the pressure, the higher the solubility and vice versa. Under ambient conditions, the solubility of oxygen is about 1×10⁻³ mole/liter in pure water. Thus it provides an automatic control of available oxygen for the controlled oxidation process. As the dissolved oxygen is consumed more oxygen from the air dissolves into the solution to maintain the solubility equilibrium.

Raney nickel is an alloy of nickel and aluminum in the proportion of 50 weight percent each. The active nickel catalyst is the high surface area nickel that is obtained by subjecting the aluminum-nickel alloy to an etching treatment in hot concentrated alkali. During the etching process, the aluminum (and aluminum rich alloy) is leached into the alkali solution to form aluminate leaving behind finely divided active nickel catalyst in a particulate form. This active nickel particulate is highly pyrophoric and has to be passivated before exposure to air.

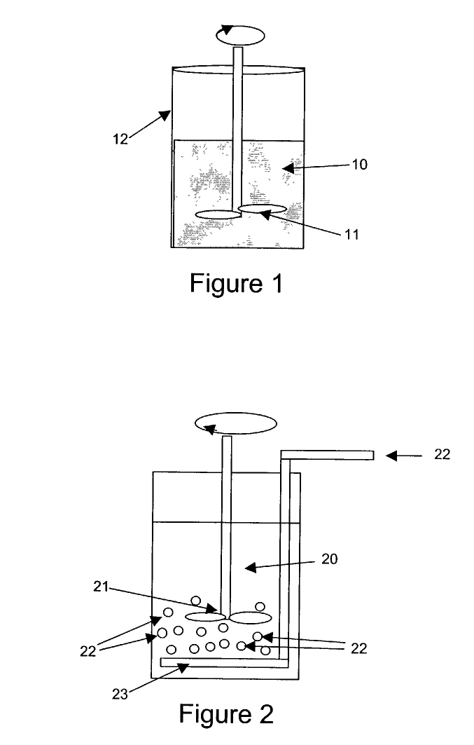

To produce the active nickel catalyst, a 50:50 aluminum-nickel alloy (Raney nickel) undergoes an etching treatment in a concentrated alkali solution at a temperature ranging from 75 to 85° C. undergoing constant agitation. Shown in FIG. 1, is an example of the apparatus used to etch the Raney nickel. The alkali solution 10 may be a 30 weight percent KOH or NaOH solution. The crushed aluminum-nickel alloy powder should be slowly added to the alkali solution 10 so as not to create a substantial increase in the solution temperature by vigorous reaction. A paddle stirrer 11 or another type of stirring mechanism is used to constantly agitate the solution during the etching process. When etching the aluminum-nickel alloy, the temperature of the alkali solution should be maintained at approximately 100 to 105° C. When the aluminum-nickel alloy is introduced to the alkali solution, a vigorous reaction transpires resulting in the evolution of gaseous hydrogen. Because of the temperature and copious evolution of gases, there will be a loss of water. Deionized water should be added to the solution to compensate for such loss. After the initial reaction, the reaction rate will slow down. Agitation of the alkali solution should continue for approximately 4 to 5 hours to ensure that the reaction has subsided. Once the solution has cooled, the supernatant fluid consisting of alkali solution with dissolved aluminate is decanted. It is important to completely remove all of the supernatant fluid because presence of the supernatant fluid during the washing process will cause the aluminates to hydrolyze and coat the active nickel catalyst particles with aluminum hydroxide, which is difficult to remove. After removing all of the supernatant fluid, the active nickel catalyst particles are washed with water until the pH of the rinse water is near 7 ensuring removal of the last traces of the alkali solution. The active nickel catalyst particles must remain submerged in the water at all times to avoid spontaneous combustion.

After the etching process, the active nickel catalyst undergoes passivation. Shown in FIG. 2, is an example of the apparatus used to passivate the active nickel catalyst particles. The active nickel catalyst particles are suspended in distilled water to create a active nickel catalyst suspension 20, which undergoes constant mechanical agitation with a paddle stirrer 21. Oxygen 22 is sparged into the active nickel catalyst suspension 20 using a porous dispersant 23. While the active nickel catalyst particles are vigorously agitated, they come into contact with the dissolved oxygen and begin to oxidize at the surface of the particles. The amount of oxygen sparged into the suspension 20 should be sufficient to ensure passivation of the active nickel catalyst, the progress of which is monitored by measuring the water temperature. Since the amount of oxygen available for oxidation is limited, there is no rapid rise in temperature. However, the temperature of the solution rises to a temperature just exceeding 40° C. from an ambient of 25° C. during the oxidation. As a general guideline the following is the typical temperature rises indicating that the process is going well:

After the 1^{st} hour of bubbling the temperature of the solution should rise to at least to 30° C.

After the 2^{nd} hour of bubbling the temperature of the solution should rise to at least to 40° C.

After the 3^{rd} hour of bubbling the temperature of the solution should rise to at least to 42° C.

After the 4^{th} hour of bubbling the temperature of the solution should rise to at least to 42° C.

After the 5^{th} hour of bubbling the temperature of the solution should rise to at least to 42° C.

Thereafter the solution cools down indicating that the reaction is over. Any further sparging with oxygen does not change the temperature once the oxidation is complete. Once the oxidation is complete, the passivated active nickel catalyst particles are filtered and washed again using deionized water. It can be dried safely in air between 25 to 35° C. without any combustion. The passivated active nickel catalyst should be air dried for approximately 24 hours. Within the first 15 minutes if there is no heat developed, the material is passivated. When almost all of the water has evaporated from the active nickel catalyst, the active nickel catalyst should be cool to touch. If the active nickel catalyst warms up, add water and bubble oxygen for another 0.5 hour. It is possible to accelerate or decelerate the reaction by adjusting the temperature of the water and dispersing the gases in extremely fine bubbles. It is also possible to use ozonized oxygen to accelerate the reaction.

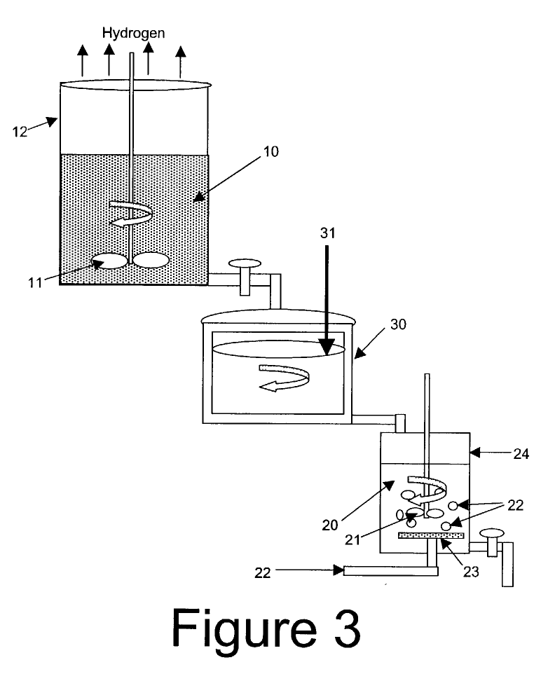

Exemplified in FIG. 3 is an apparatus that may be used in accordance with the present invention. Using this apparatus, a 50:50 aluminum-nickel alloy (Raney nickel) is slowly added to an etching vat 12 filled with an alkaline solution 10 containing 30 weight percent KOH. After adding the aluminum-nickel alloy, the mixture is agitated using a paddle stirrer 11 thus producing the active nickel catalyst and evolving hydrogen gas. The active nickel catalyst then flows into a centrifuge 30 constantly supplied with deionized water 31. The use of the centrifuge 30 inhibits the formation of aluminate on the surface of the active nickel catalyst particles. The rinsed active nickel catalyst particles then pass into the passivation vat 24 where the active nickel catalyst particles form a suspension 20 in deionized water undergoing constant agitation with a paddle stirrer 21. Oxygen 22 is bubbled into the passivation vat 24 using a porous dispersant 23 at a rate sufficient to maintain the level of oxygen 22 required to ensure passivation of the active nickel catalyst particles.

### EXAMPLE

A sample of the active nickel catalyst was prepared using the process in accordance with the present invention in a laboratory setting. To begin etching of the 50:50 aluminum-nickel alloy, 6.4 liters of 30% KOH was heated in a stainless steel stockpot with gentle mechanical stirring to a temperature of 80° C. Approximately 800 grams of nickel aluminum alloy (called the Raney Alloy) was gradually added to the hot alkali solution over a period of about 45 minutes. The temperature of the solution gradually increased to about 100 to 105° C. from the starting temperature of 80° C. The temperature was maintained at this level for the duration of the reaction. Because of the water loss resulting from the temperature and evolution of gases, deionized water was continually added to maintain the preset solution level.

After mixing for approximately 4.5 hours the reaction had subsided. The stirring was ceased and the solution was allowed to cool and settle. The supernatant liquid was completely removed and the active nickel catalyst particulate was washed with deionized water until the pH of the rinse water reached 7. The resulting active nickel catalyst particulate slurry was then transferred to a stainless steel vessel while maintaining minimal direct exposure to air.

To passivate the active nickel catalyst material, the active nickel catalyst particulate was suspended in 7 liters of deionized water in a stainless steel vessel at room temperature. Also included in the stainless steel vessel were a mechanical paddle stirrer, a 10″ long porous ceramic bubbler and a thermometer. Ultrapure oxygen was distributed into the active nickel catalyst suspension via the ceramic bubbler. The stirrer was set at approximately 770 RPM. Once the slurry was in motion and well agitated, oxygen was bubbled into the solution (Set pressure at 50-55 mm or equivalent to 6400-7500 std.ml/min). The temperature was measured every hour to ascertain the progress of the oxidation. Within the first hour the temperature of water had to risen to 30° C. Bubbling and stirring then continued for 5.5 hours. After 5.5 hours oxygen bubbling and mechanical stirring was ceased and the material was allowed to settle down. The supernatant liquid was drained and the passivated active nickel catalyst particles were rinsed with 4 liters of DI water. The active nickel catalyst was then air dried for 24 hours.

1. A process for the production of a passivated Raney nickel particulate comprising the steps of:
1) etching an aluminum-nickel alloy in an alkali solution to form a Raney nickel particulate;
2) suspending said Raney nickel particulate in deionized water at room temperature;
3) agitating said Raney nickel particulate suspension; and
4) bubbling an oxygen containing stream into said Raney nickel particulate suspension.

2. The process according to claim 1, wherein said aluminum-nickel alloy is a 50:50 aluminum-nickel alloy.

3. The process according to claim 1, wherein said oxygen containing stream is bubbled into said Raney nickel suspension for 5.5 hours.

4. The process according to claim 3, wherein the temperature of said Raney nickel particulate suspension is at least 30° C. after 1 hour.

5. The process according to claim 3, wherein the temperature of said Raney nickel particulate suspension is at least 40° C. after 2 hours.

6. The process according to claim 3, wherein the temperature of said Raney nickel particulate suspension is at least 42° C. after 3 hours.

7. The process according to claim 3, wherein the temperature of said Raney nickel particulate suspension is at least 42° C. after 4 hours.

8. The process according to claim 3, wherein the temperature of said Raney nickel particulate suspension is at least 42° C. after 5 hours.

9. The process according to claim 1, further comprising the steps of:
1) allowing said Raney nickel suspension to settle;
2) removing the supernatant liquid;
3) allowing said passivated Raney nickel particulate to air dry for 24 hours.
